(19) United States
(12) Patent Application Publication
(10) Pub. No.: US 2005/0007000 A1
(43) Pub. Date: Jan. 13, 2005

(54) Brightness and contrast enhancement of direct view emissive displays

(75) Inventors: Hsin-Hsin Chou, Woodbury, MN (US); Robert S. Moshrefzadeh, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/913,845

(22) Filed: Aug. 6, 2004

Related U.S. Application Data
(63) Continuation of application No. 09/705,203, filed on Nov. 2, 2000.

(51) Int. Cl. H01J 1/62

(52) U.S. Cl. 313/116; 313/483

(57) ABSTRACT

Emissive displays can include a plurality of independently operable light emitters that emit light through one or more transmissive layers. The emissive displays further include elements disposed between the light emitters and the transmissive layers to frustrate total internal reflections that can occur at one or more of the interfaces created by the transmissive layers, such as at an interface between the light emitter and a transmissive layer or at an interface between a transmissive layer and air. By frustrating total internal reflections, the brightness of the emissive display can be enhanced. Elements for frustrating total internal reflections include volume diffusers, surface diffusers, microstructures, and combinations of these or other suitable elements.

The present invention relates to emissive displays and lamps, and to elements for enhancing the brightness and/or the contrast of emissive displays and lamps.

### BACKGROUND

Information displays have many applications ranging from handheld devices to laptop computers, from televisions to computer monitors, from automobile dashboard displays to signage applications, and so on. Many of these displays rely on internal lighting to either display the information directly (such as with displays that include segmented or pixilated light emitting devices) or illuminate a panel that displays information to viewers (such as with liquid crystal displays and back lit graphics). Increasing the brightness of light emitting devices often increases the viewability of such displays. However, there can be constraints such as maximum power requirements that may limit the ability to readily increase brightness. For example, laptop computer monitors that include back lit liquid crystal displays often use an internal battery to power the light source. Increasing light output from the light source can be a heavy drain on the battery. To reduce power requirements and extend battery lifetimes, microprism optical films have been used, for example to redirect wide angle light that is not typically viewed into a narrower cone of angles that cover a more typical viewing range. This increases the apparent brightness of the display while using the same or less battery power. Reflective polarizers have also been developed for liquid crystal displays that can help recycle light having the undesired polarization state (which would otherwise be lost to absorption), thereby significantly increasing the available light. In these cases, brightness of displays have been increased by redirecting or reusing light that has already exited the light emitting device.

### SUMMARY OF THE INVENTION

The present invention contemplates enhancing the brightness of emissive devices and displays illuminated using emissive devices by coupling more light out of the emissive devices. This is different from known brightness enhancement efforts that redirect and/or recycle light that has already left the emissive device. The present invention can thus be used to increase the amount of light that is emitted out of the emissive device without necessitating an increase in the supply of power to the light emitting device.

Emissive devices that emit light toward a viewer or display panel generally do so through one or more transmissive layers. The emitted light can be subject to total internal reflection at one or more of the interfaces introduced by these layers. The present invention provides elements to frustrate total internal reflection at one or more of such interfaces and allow more light to be transmitted toward a viewer. In cases where the emissive device is itself an information display, the present invention also provides elements to maintain resolution and/or to enhance contrast between pixels or segments of the display.

In one aspect the present invention provides a light emitting device that includes a light emitter disposed to emit light through a transmissive layer toward a viewer, and a volume diffuser disposed to direct toward the viewer at least a portion of the light emitted into the transmissive layer that would otherwise be totally internally reflected. For example, the volume diffuser can be positioned between the light emitter and the transmissive layer or between the transmissive layer and the viewer. The transmissive layer can be a substrate (such as glass or a plastic film) on which the light emitter has been formed, or can be a layer such as a protective layer formed over or laminated onto the light emitter, for example. The light emitter can be any suitable emitter such as an electroluminescent emitter, an organic emitter such as a light emitting polymer device, a phosphor-based emitter, and the like.

In another aspect the present invention provides a light emitting device that includes a substrate, an organic light emitter disposed to emit light through the substrate, and a frustrator element disposed between the substrate and the organic light emitter to frustrate total internal reflections of light emitted from the organic light emitter in the light emitting device. The frustrator element can be a volume diffuser, a surface diffuser, a microstructured surface, an antireflective coating, or any suitable combination of these and/or other elements that can be used to frustrate total internal reflections.

In yet another aspect the present invention provides an emissive device that includes a light emitter capable of emitting light through one or more transmissive layers included as part of the emissive device, and a means for increasing the brightness of the emissive device by frustrating total internal reflections at one or more interfaces created by the one or more transmissive layers.

In still another aspect the present invention contemplates a back-lit display that includes a back light for illuminating a display element capable of displaying information when illuminated using the back light. The back light includes a light emitting device disposed to emit light through a transmissive layer and a frustrator element disposed between the light emitting device and the transmissive layer to frustrate total internal reflections, thereby coupling more light out of the back light as compared to an otherwise identical back light without the frustrator element.

In another aspect, the present invention provides an information display that includes a plurality of independently operable emissive devices disposed to emit light through a transmissive layer, thereby being capable of displaying information to a viewer, and a frustrator element disposed between at least one of the emissive devices and the transmissive layer to frustrate total internal reflections of light emitted the at least one emissive device.

Brightness enhancement elements of the present invention can also be combined with other optical elements that redirect, recycle, or otherwise mange light in a display.

### BRIEF DESCRIPTION OF THE DRAWINGS

FIG. 1 is a schematic representation of an emissive display;

FIG. 2 is a schematic representation of potential interfaces for total internal reflection in an emissive display;

FIGS. 3(a) and (b) are schematic representations of emissive displays that include volume diffusers;

FIGS. 4(a) and (b) are schematic representations of emissive displays that include surface diffusers;

FIGS. 5(a) and (b) are schematic representations of emissive displays that include microstructured elements; and

FIG. 6 is a schematic representation of an emissive display that includes microlouvers.

### DETAILED DESCRIPTION

The present invention relates generally to improved emissive displays that include elements to enhance the brightness and/or to enhance the contrast of the displays.

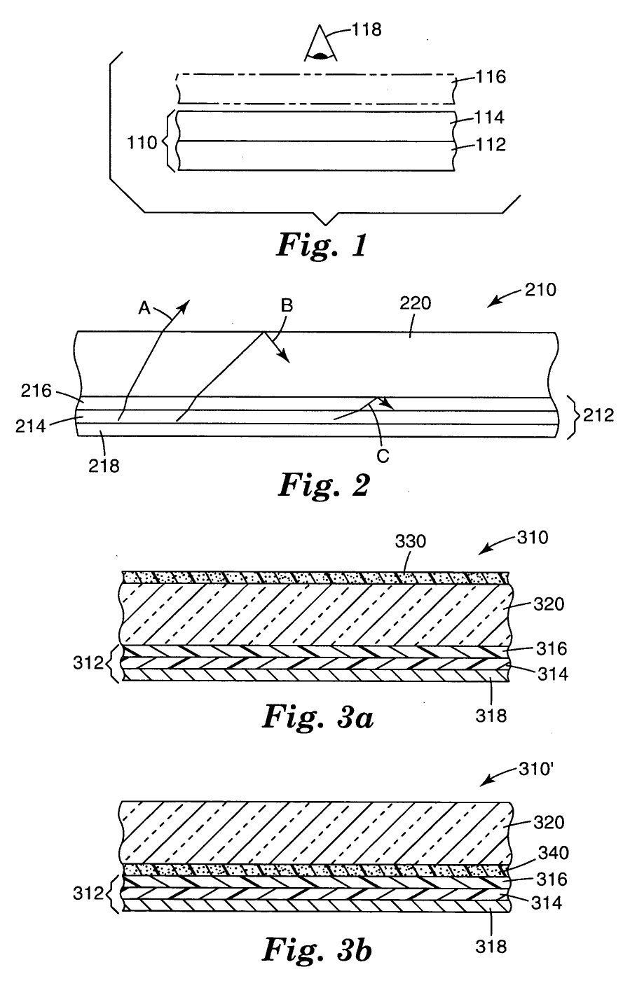

FIG. 1 shows a stylized representation of a light emitting device 110 that includes a light emitter 112 and one or more light transmissive layers 114. The device 110 is fashioned so that the light emitter 112 can emit light through the transmissive layer(s) 114 toward a viewer 118. The viewer side of the device 110 can be conventionally referred to as the front side, with the opposite side correspondingly referred to as the back side. Between the viewer 118 and the transmissive layer(s) 114 there is a region 116 that has a lower index of refraction than the transmissive layer(s) 114. Region 116 typically includes air, and may be entirely made up of air, but can also include various films (e.g., anti-glare films or coatings, anti smudge films or coatings, etc.), optical elements (e.g., polarizers, filters, wave plates, lenses, prismatic films, etc.), user interface devices such as touch screens, and other elements disposed alone or in combination, and disposed with or without air gaps between transmissive layer(s) 114 and the elements, and/or with air gaps between separate elements in the region 116. When it is preferred that no air gaps exist between separate elements, an optical adhesive can be used to bond the elements together.

During operation of the device 110, a portion of the light emitted from light emitter 112 toward the viewer might enter the transmissive layer(s) 114 at angles such that the light is totally internally reflected within one or more of the transmissive layers 114. Total internal reflection (TIR) of light is a well-known phenomenon that can occur when light travelling in a medium encounters an interface with a lower refractive index medium, and the angle of incidence of the light at that interface exceeds the critical angle. Thus, in the path of light from the light emitter 112 to the viewer 118, any interface at which the light encounters a decrease in refractive index is a possible surface for total internal reflection. Such total internal reflections can prevent light from reaching the viewer 118 and can reduce the brightness of the device 110. The present invention contemplates, among other things, making brighter emissive displays by including elements that couple more light out of the displays by frustrating TIR.

Light emitting device 110 can include any suitable emissive devices such as electroluminescent (EL) devices, organic electroluminescent devices (OLED), inorganic light emitting diodes (LED), phosphor-based backlights, phosphor-based direct view displays such as cathode ray tubes (CRT) and plasma display panels (PDP), field emission displays (FED), and the like. The light emitting device can be a backlight or a direct view display; it can emit white light, monochrome color light, multiple colors, or full color (e.g., RGB, or red, green, blue); and it can also be a segmented (e.g., low resolution) or a pixilated (e.g., high resolution) display.

Light emitter 112 can be any suitable material, set of materials, component, or group of components that are disposed to emit light when appropriately stimulated. Examples include inorganic electroluminescent (EL) materials that emit light when subjected to an electric field (e.g., an EL material can be disposed between an anode and a cathode so that when a potential is applied between the anode and cathode, light is produced), phosphorescent materials that emit visible light when exposed to ultraviolet radiation, and other materials. An exemplary light emitter is one that includes materials to make an OLED. OLED light emitters are typically layered structures that include an organic light emitting material sandwiched between an anode and a cathode. As is known in the art, other layers can be present, such as electron transport and/or injection materials disposed between the cathode and the organic light emitter, hole transport and/or injection materials disposed between the anode and the organic light emitter, and the like. Organic light emitting materials can include small molecule emissive material, light emitting polymers, doped light emitting polymers, and other such materials and combinations of materials now know or later developed. When an OLED device is subjected to an electric field applied between the anode and cathode, electrons and holes can be created and injected into the device. The electron/hole pairs can combine in the organic light emitting material, and the energy gained in the recombination can produce a particular color or colors of visible light, for example. The produced light is generally emitted isotropically.

Multi-color OLED displays can be made by adjacently disposing OLED devices that emit different colors of light and making the devices independently addressable. Multi-color OLED displays can also be made by using color filters either to improve color purity, enhance color contrast, or to introduce color when white light or other monochromatic OLEDs are used.

Referring again to FIG. 1, transmissive layer(s) 114 can be any layer or layers disposed between the viewer and the light emitter in a light emitting device that are transparent, or at least sufficiently transmissive, of wavelengths of light intended to reach the viewer. For example, the transmissive layer(s) can include a glass or plastic substrate on which the light emitters or other devices for operating the light emitting device are formed (e.g., thin film transistors). The transmissive layer(s) can also include transparent electrodes, protective layers, barrier layers, color filters, wave plates, polarizers, and any other suitable transmissive layer found in light emitting devices. Typically, there is no air gap between transmissive layer(s) 114 and light emitter 112, although there can be an intervening layer or layers.

According to the present invention, elements can be included in light emitting devices to frustrate total internal reflections to couple, or redirect, more light out of a device toward the viewer. Referring again to FIG. 1, such elements (termed “TIR frustrators” in this document) can be disposed between light emitter 112 and transmissive layer(s) 114, between transmissive layer(s) 114 and viewer 118, and/or between separate transmissive layers 114 or within one or more transmissive layer(s) 114. As described in more detail in the discussion that follows, TIR frustrators can include volume diffusers, surface diffusers, microstructures, buried microstructures, layered constructions, louvered constructions, and combinations of these.

FIG. 2 can be used to exemplify concepts of light trapping in an emissive display device. Without loss of generality, FIG. 2 shows an emissive display 210 that includes, for example, an OLED device 212 disposed on a glass substrate 220. OLED device 212 includes an organic emitter layer 214, a transparent anode 216, and a cathode 218. The space between the display 210 and the viewer is air in this example. Organic emitter 214 can be approximated as an isotropic light source, with light being emitted over a wide range of angles. Cathode 218 is typically reflective so that light emitted toward the back of the display 210 can be redirected forward. Glass substrate 220 has a higher index of refraction than air (refractive index of air is about 1, and a typical refractive index of glass is about 1.5), and transparent anode 216 typically has a higher index of refraction than glass substrate 220. Exemplary transparent anodes include transparent conductive oxides such as indium tin oxide (ITO), which typically have an index of refraction of about 1.8.

Thus, in FIG. 2, light emitted toward the viewer can encounter two interfaces where TIR can occur, namely at the anode/substrate interface and the substrate/air interface. As such, at least three types of light rays can be examined. First, light ray A represents light emitted at angles less than the critical angle for TIR at either the anode/substrate interface or the substrate/air interface. Light ray B represents light emitted at angles less than the critical angle for TIR at the anode/substrate interface, but greater than the critical angle for TIR at the substrate/air interface. Light ray B can thus be considered “trapped” in the display. Light ray C represents light emitted at angles greater than the critical angle for TIR and the anode/substrate interface. Light ray C can likewise be considered “trapped” in the display. According to the present invention, TIR frustrators can be used to frustrate TIR at any or all interfaces where TIR can occur as light propagates toward a viewer, including at the anode/substrate interface or the substrate/air interface.

Taking the situation depicted in FIG. 2 and using a glass substrate (refractive index of 1.51), an ITO anode (refractive index of 1.8) and an organic light emitter (refractive index of 1.7), the following can be calculated. At the ITO/glass interface (216/220 interface in FIG. 2), light will be totally internally reflected that was emitted from the organic light emitter at angles of about 630 or more (measured from the normal in the light emitting layer 214). This constitutes about 46% of the emitted intensity. At the glass/air interface, light will be totally internally reflected that was emitted from the organic light emitter at angles of about 36° to about 63° (light emitted at higher angles will not reach this interface due to TIR at the ITO/glass interface). This constitutes an additional 35% of the emitted intensity. The intensity of light ultimately transmitted through the display 210 is therefore about 19% of the light produced by the organic light emitter 214. Frustrating at least a portion of the TIR at one or both of the identified interfaces provides great potential to increase the total amount of transmitted light.

The situation depicted in FIG. 2 applies more generally than OLED displays. A more general situation is one where an emissive material is disposed to emit light through a high index material, such as a transparent conductive material, then through a substrate, then through air toward a viewer, where the index of the substrate is less than the index of the high index material, and the index of the substrate is greater than the index of air.

FIGS. 3(a) and (b) show the use of volume diffusers as TIR frustrators in emissive displays 310 and 310′. Emissive displays 310 and 310′ each include a substrate 320 and a light emitting device 312 disposed on the substrate, the device 312 having an emitter layer 314, a transparent electrode layer 316, and a back electrode layer 318.

FIG. 3(a) shows a volume diffuser 330 disposed on the substrate 320 and located on the front side of the display 310. Volume diffusers can be described as including scattering centers disposed in a matrix, or binder. The difference in index between the scattering centers and the matrix is preferably large enough to scatter a portion of the light toward a viewer that would otherwise be totally internally reflected due to its angle of incidence. In FIG. 3(a), the matrix of volume diffuser 330 preferably has an index of refraction that is about the same as or higher than the index of the substrate 320. This can allow light rays to enter volume diffuser 330 without TIR at the substrate/volume diffuser interface. Light rays that enter volume diffuser 330 at normal or near normal incidence can generally pass through toward an observer unobstructed by scattering centers. Light rays propagating at angles that would otherwise be totally internally reflected at the substrate/air interface can enter the volume diffuser 330 and be scattered. At least a portion of the scattered light is redirected toward the viewer at angles less than the critical angle and can thus be coupled out of the device, thereby increasing brightness. Light scattered at angles higher than the critical angle can be totally internally reflected in volume diffuser 330 to repeat the scattering process, thereby coupling even more light out of the display device.

FIG. 3(b) shows a volume diffuser 340 disposed between the substrate 320 and the light emitting device 312 of display 310′. The matrix of volume diffuser 340 preferably has an index of refraction that is about the same as or higher than the index of the transparent electrode layer 316. This can allow light rays to enter volume diffuser 340 without TIR at the transparent electrode/volume diffuser interface. Light rays that enter volume diffuser 340 can generally pass through toward an observer unobstructed by the scattering centers. Light rays propagating at angles that would otherwise be totally internally reflected at the electrode/substrate interface can enter the volume diffuser 340 and be scattered. At least a portion of the scattered light is redirected toward the viewer at angles less than the critical angle and can thus be coupled out of the device, thereby increasing brightness. Light scattered at angles higher than the critical angle can be totally internally reflected at the volume diffuser/substrate interface to repeat the scattering process, thereby coupling even more light out of the display device.

Exemplary volume diffusers have a low enough density of scattering centers so that a significant proportion of light emitted at angles that would not otherwise be susceptible to TIR in the light emitting device (e.g., normal or near normal incidence light) has a relatively small chance of being scattered. In addition, exemplary volume diffusers have a high enough density of scattering centers so that a portion of light emitted at higher angles of incidence (e.g., angles larger than the critical angle) can be scattered toward the viewer, thereby coupling high angle light out of the device toward the viewer. Due to the nature of the optical path difference of low angle incidence light rays versus high angle incidence light rays within the volume diffuser element, low angle incidence light rays are statistically less likely to encounter scattering centers than high angle incidence light rays because they spend less time on average and traverse less distance in the diffuser on average than higher angle incidence light. In addition, high angle incidence light rays that do not encounter scattering centers upon a first traversal through the thickness of the volume diffuser may be totally internally reflected at the volume diffuser/substrate interface or at the volume diffuser/air interface (or other applicable interface) and have another chance to be scattered out of the layer toward the viewer.

Volume diffuser TIR frustrators such as those depicted in FIGS. 3(a) and (b) may be provided by any suitable means. For example, a suitable volume diffuser can be provided as a film and bonded to the substrate and/or to the light emitting device and/or to other components by use of an optical adhesive. Exemplary optical adhesives have indices of refraction that are about the same as or greater than the index of refraction of the layer of the light emitting device that is located immediately behind the optical adhesive layer in the display construction. As another example, the volume diffuser may include low index particles, high index particles, air bubbles, voids, regions of phase-separated material, and the like, disposed in an appropriate optical adhesive or other suitable adhesive or binder suitable for bonding. In this case, the volume diffuser can be coated onto a layer of the light emitting device, such as the substrate, a transparent electrode, an optical film, or other component, and can be used to bond a portion of the device to another portion of the device, or to additional optical films or other components such as those that may be optionally provided on the front of the display. In other embodiments, the volume diffuser may include particles or air bubbles diffused into or otherwise disposed within the substrate or portion of the substrate. For example, particles may be disposed within a glass frit and suitably coated, leveled, and fired to form a glass substrate, or a layer on a glass substrate, that acts as a volume diffusing TIR frustrator. Similarly, particles can be mixed in a binder that can be formed into a polymeric substrate, or a polymeric layer on a substrate, that acts as a volume diffusing TIR frustrator.

As described above, volume diffuser TIR frustrators typically include scattering sites disposed within a matrix, or binder. Matrix materials can include any suitable material that is transmissive of desired wavelengths. Matrix materials preferably have a refractive index that is about the same or higher than the refractive index of the adjacent layer in the display below the volume diffuser. Examples of matrix materials include optical adhesives, thermoplastics, photopolymers, thermal setting materials, epoxies, polyimides, nanocomposite materials, and the like. The volume diffuser matrix can be a single, homogeneous material, or the matrix can include more than one material. For example, the composition of the matrix can vary through the thickness of the matrix to vary the refractive index, the transmissivity, and/or other properties of the matrix through the thickness of the volume diffuser. Such thickness-varied constructions are referred to here as layered constructions. As another example, the composition of the matrix can vary in the plane of the volume diffuser, such as having alternating regions of higher and lower refractive index, regions of higher and lower optical density, and/or other properties depending on the horizontal position in the volume diffuser. Such horizontally-varied constructions are referred to here as louvered constructions. Louvered constructions can be useful in altering the optical path of high angle incidence light, for example to frustrate TIR of high angle incidence light without adversely effecting low angle incidence light in significant amounts. As with scattering sites in volume diffusers, high angle incidence light will tend to sample more of the region-to-region optical variations in louvered constructions than will low angle incidence light.

Scattering centers can include particles, voids (e.g., air bubbles or pockets), phase dispersed materials, and the like, disposed in the matrix of the volume diffuser. If not specified, the terms “particles” “scattering sites”, and “scatterers” will be used synonymously in reference to scattering sites in volume diffusers. Generally, more efficient scattering can occur when the index difference between the scattering sites and the matrix is higher. More than one type of scatterer can also be used. For example, a high index particle type and a low index particle type can be used in the same volume diffuser. Particle loadings will generally depend on the application. In lamp, or backlight, applications for example, particle loadings are preferably high enough to couple more light out of the display toward the viewer as compared to a display with no volume diffuser, and yet low enough to allow a desired amount of normal and near-normal light to pass through the volume diffuser unobstructed. Particle loading can depend on the thickness of the volume diffuser, the position of the volume diffuser in the display, the refractive indices of the scatterers, the size of the scatterers, the material of the matrix, and other elements of the display, the particular display application, and other such concerns.

Scattering centers can be any suitable size for disbursement throughout the matrix and for desired interaction with light propagating through the volume diffuser. Exemplary scatterers are on the order of or larger than wavelengths of light to be scattered and at least somewhat smaller than the thickness of the volume diffuser. Scatterers can be any desired shape, for example spherical, acicular, flat, elongated, etc. Scatterers can also be oriented in particular directions in the matrix. For example, a volume diffuser could be a microporous film that includes a matrix and a plurality of elongated air pockets, or cylindrical voids, having their long axes aligned with the thickness direction of the film. As another example, a volume diffuser could include a plurality of elongated scatterers oriented in a co-linear fashion along a particular direction such as in the thickness direction of the diffuser or along an axis in the plane of the diffuser. Elongated or acicular scatterers that are oriented in the volume diffuser can give rise to asymmetric viewing properties, for example providing for enhanced brightness over a broad range of viewing angles in a horizontal direction while providing enhanced brightness over a narrower range of viewing angles in a vertical direction.

Particularly suited volume diffusers include: microporous films including the microporous polypropylene films available from Minnesota Mining and Manufacturing Company under the trade designation 3 M 1472-4, and hot extruded cellulose acetate films such as those used for backings on transparent adhesive tape sold by Minnesota Mining and Manufacturing Company; suitable transmissive binders such as acrylics, thermoplastics, polyethylene teraphthalate (PET), photopolymers, optical adhesives, and others dispersed with white inorganic particles such as TiO₂, Sb₂O₃, Al₂O₃, ZrSiO₄, and other such materials, with weight or volume fractions of particles to binder ranging from 1% to 50% and particle sizes of less than a micron to 10 or more microns; suitable transmissive binders such as acrylics, thermoplastics, PET, photopolymers, optical adhesives, and others dispersed with organic particles such as polystyrene particles, particles of polytetrafluoroethylene (generally available under the trade designation Teflon), and others, with weight or volume fractions of particles to binder ranging from 1% to 50% and particle sizes of less than a micron to 10 or more microns; and phase-separated composites such as polystyrene dispersed in polyethylene. Volume diffusers that include particles dispersed in a binder can typically be formed by solution coating or otherwise suitable coating onto a PET or polycarbonate film or other suitable film. Thickness of the volume diffuser can vary, with typical thicknesses being in a range from about 1 micron to 50 microns. Particle size can vary depending on the particle type and other considerations, with typical particle sizes being in a range from about 1 micron or less to 10 microns. Particle sizes in a range of about 1 to 5 microns may be preferable to reduce color dispersion.

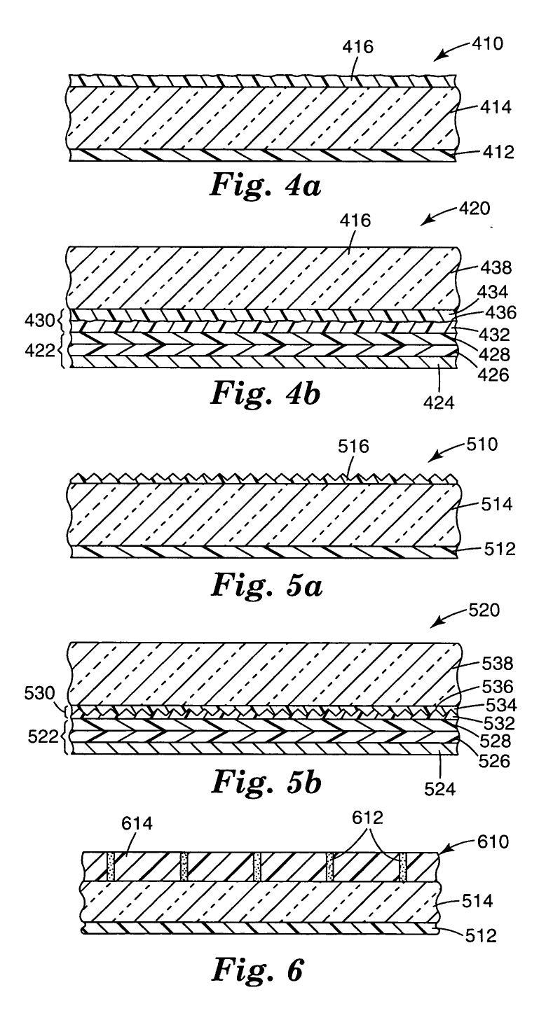

Exemplary TIR frustrators also include surface diffusers. FIGS. 4(a) and (b) show examples of emissive displays that include surface diffusers. FIG. 4(a) shows an emissive display 410 that includes an emissive device 412, a light transmissive substrate 414, and a surface diffuser 416. The transmissive substrate 414 is disposed between the device 412 and the surface diffuser 416. Surface diffuser 416 preferably is made of a material that is substantially transmissive to light of the desired wavelengths and that has a refractive index that is close to the refractive index of the substrate 414 or larger. Surface diffuser 416 has a roughened surface oriented toward the viewer.

FIG. 4(b) shows an emissive display 420 that includes an emissive device 422, a surface diffusing element 430, and a transmissive substrate 438. Emissive device 422 can include, as shown, an emissive layer 426 disposed between electrodes 424 and 428. Surface diffusing element 430 is shown to include two layers 432 and 434. One of layers 432 and 434 is typically a layer that has been imparted with a roughened, or diffusive, surface 436. The other of the two layers 432 and 434 can be an optically clear adhesive or some other transmissive material used to laminate the diffusive layer to substrate 438 or device 422, as the case may be. Aside from a bonding function, the adhesive layer can serve to coat over the rough surface of the diffusing layer so that air gaps do not exist between elements. Alternatively, a non-adhesive layer can be used, for example to planarize the rough surface, without necessarily providing an adhesive function. Layers 432 and 434 have different indices of refraction, preferably with layer 432 having a higher index than that of layer 436. Preferably, layer 432 has about the same or higher index of refraction than electrode 428 or another layer (not shown) that might be disposed between electrode 428 and layer 432.

As shown, surface diffusers can be positioned at interfaces where total internal reflections can reduce the brightness of emissive displays. Surface diffusers can couple more light out of emissive displays toward the viewer by scattering high angle incidence light, thereby frustrating TIR. Surface diffusers can also provide a matte look to a display, especially when provided immediately between the display and the viewer. This can reduce glare caused by ambient light reflections and thereby improve the apparent contrast of the display. Surface diffusers can be provided by embossing or otherwise roughening the surface of elements already included in the display. Additional layers can also be added specifically for providing a diffusive surface. Also, other TIR frustrators such as volume diffusers can be additionally provided with a diffusive surface.

Particularly suited surface diffusers include: matted polycarbonate, PET, or other suitable films; stretched polyethylene films; sandblasted films; thermally embossed surface structured films such as embossed cellulose acetate films; clear beaded screen film (e.g., films made from partially embedding sub-millimeter sized glass beads in a transparent binder on a transparent substrate); laser polymerized randomly structured diffuser formed on a clear substrate; randomly laser drilled film; and other such randomly structured, matted, or embossed films. Any surface structure used for a surface diffuser can also be used to make another surface diffuser that has an inverted structure by embossing a film with the original structure, or forming a film by coating onto the original structure.

Exemplary TIR frustrators also include microstructured surfaces. In general, microstructures can be described as intended, and often repeating, protrusions and/or indentations in a surface that have dimensions measured in microns or tens of microns. It is well known that microstructured elements can be used to manage or alter the direction and distribution of light. For example, prismatic films have been used in liquid crystal displays to restrict the cone of angles in which light is transmitted to increase the apparent brightness of the display when viewed at normal incidence or small viewing angles.

FIG. 5(a) shows an emissive display 510 that includes an emissive device 512 disposed on a transparent substrate 514, and a microstructured film 516 disposed on the viewer side of substrate 514. Microstructured film 516 can act as a TIR frustrator. Microstructured film 516 preferably has a refractive index that is about the same as, or higher than, the refractive index of the substrate 514.

FIG. 5(b) shows an emissive display 520 that includes a microstructured element 530 disposed between an emissive device 522 and a transparent substrate 538. Emissive device 522 can emit light through microstructured element 530 and substrate 538 toward a viewer. Emissive device 522 is shown to include an emissive layer 526 sandwiched between electrodes 524 and 528. Microstructured element 530 is shown to include two layers 532 and 534 with a microstructured interface 536 between them. Typically, one of layers 532 and 534 is a microstructured film, and the other layer is an adhesive or other material used to fill in the microstructured surface of the microstructured film. In this way, microstructured element 530 has two flat surfaces, for example, that can be bonded, laminated, or otherwise disposed between other elements in the display such as the substrate and the emissive device(s). This creates what can be considered as a buried microstructure. Layers 532 and 534 have different indices of refraction, preferably with layer 534 having a higher index of refraction than layer 532. Further, layer 532 preferably has about the same or higher index of refraction than electrode 528 or other layer (not shown) that might be disposed between electrode 528 and layer 532. Microstructured element 530 can serve as a TIR frustrator for light that would otherwise be totally internally reflected at the interface between electrode 528 and substrate 538.

For emissive displays, microstructured elements can be used alone or in combination with other elements (such as volume diffusers) to frustrate TIR and/or to redirect light to angles that are less likely to exceed the critical angle for TIR at a subsequently-encountered interface before reaching the viewer.

Particularly suited microstructures include: lenticular lens sheeting; micro-lenslet arrays; beaded or cube-cornered retroreflective sheeting; prismatic and other optical enhancement films such as those sold by Minnesota Mining and Manufacturing under the trade designation Brightness Enhancement Film; diffraction gratings; and other suitable microstructured films. Microstructures can also be used as molds to form other microstructured films that have an inverted microstructure.

Microstructured films can be laminated or otherwise disposed on the front side of an emissive display, typically with the microstructured surface of the film facing the viewer, with the opposing surface of the film being smooth. Microstructured films can also be oriented with the microstructures facing away from the viewer. Microstructures can also be provided in a buried construction where the microstructures of a microstructured film are coated over with a different material to form a film-like construction that is smooth on both sides but that has a microstructured interface in the middle.

Microstructures can be used alone or with other TIR frustrators. For example, it might be desirable to include in an emissive display a volume diffuser disposed between the emissive device(s) and a transparent substrate and to include a microstructured film on the opposing side of the substrate. Alternatively, it might be desirable to combine TIR frustrator elements into a single element that includes a microstructured surface. For example, a dispersion of volume diffuser particles in a transmissive matrix can be coated onto a microstructured surface, dried or otherwise hardened, and then removed from the microstructured surface to produce a film that is both microstructured and volume diffusive. Alternatively, a volume diffuser dispersion can be used to fill in the microstructured surface of a transmissive microstructured film to make an element that has a buried microstructure, diffusive particles, and flat surfaces for bonding to other display elements.

TIR frustrators can also be used to direct light to desired viewing angles, for example, in addition to coupling more light out of the emissive displays. For example, prismatic microstructures can be used to redirect wide angle light into a narrower cone of angles around the normal where observers are more likely to view the display. This results in an apparent increase in brightness that is in addition to the brightness gained by frustrating total internal reflections. Additionally, microstructures, gratings, and the like can be used to direct light to desired off-normal viewing angles. For example, hand held devices such as personal digital assistants, cellular phone displays, and the like, are often viewed at an off-normal angle due to natural tilting of the display. Structures that redirect light toward and around the desired off-normal viewing axis can be used to further increase the brightness of the display. In still other applications, structures on TIR frustrators can be used to restrict the available viewing angles in one direction while not restricting available viewing angles in another direction. For example, permanently mounted displays such as televisions or desk top computer monitors are often viewed from a variety of horizontal positions while typically being viewed at about the same vertical position. Structures can be used to redirect light toward the normal that would otherwise be directed toward the ceiling and the floor, for example, while still providing a wide range of viewing angles from left to right.

In additional to volume diffusers, surface diffusers, and microstructures, antireflective coatings can also be used as TIR frustrators. Antireflective coatings include multilayer coatings designed so that light of particular wavelengths reflected off one layer destructively interferes with light reflected off one or more adjacent or successive layers due to an optical path length difference of an odd multiple of one-half the wavelength. By using antireflective coatings at interfaces where total internal reflection can occur, much of the totally internally reflected light can be cancelled out due to destructive interference, thereby increasing brightness of the display. The present invention contemplates the use of antireflective coatings at any appropriate interface in an emissive display where reflections are undesired. The inclusion of antireflective coatings can be in lieu of, in addition to, or in combination with other TIR frustrators and optical elements. Exemplary antireflective coatings include broad band antireflective coatings such as boehmite (aluminum trihydrate) coatings.

The present invention contemplates the use of any suitable element to frustrate total internal reflections in emissive displays to increase brightness regardless of whether or not such elements can be or are generally categorized by any one or more of the named elements discussed above (e.g., volume diffusers, surface diffusers, microstructures, antireflective coatings, etc.).

The type of TIR frustrator used for brightness enhancement, and the construction in which it is used, generally depends on the end application. One consideration is whether the emissive device is to be used to illuminate a panel, display, or other object to be viewed (e.g., the emissive device is used as a backlight for a liquid crystal display), or the emissive device is to be used as a direct view display (e.g., the emissive device is itself an information display device, and not merely an illumination source for an information display). For some applications such as backlight and other illumination applications, an objective of a TIR frustrator might be to couple out of the device as much light as possible that would otherwise be trapped or lost due to TIR. For these applications, volume diffusers can be an exemplary choice.

Light propagating through a volume diffuser toward a viewer can pass through unobstructed toward the viewer, can be scattered and coupled out of the device toward the viewer, can pass through unobstructed at an angle higher than the critical angle and be totally internally reflected within the volume diffuser, and can be scattered at an angle higher than the critical angle and be totally internally reflected within the volume diffuser. Light totally internally reflected within the volume diffuser has a chance to encounter other scattering sites and be coupled out of the device toward the viewer. In other words, light not immediately coupled out of the device upon a first pass through the volume diffuser or upon a first scattering event can be coupled out of the device toward the viewer during subsequent passes through the diffuser and scattering events. Such light recycling in the volume diffuser can greatly increase the brightness of the emissive device. Such light recycling can also adversely affect the resolution of the emissive device if the emissive device is, for example, a direct view pixilated display, since the recycling phenomenon depends on lateral light propagation in the volume diffuser, which can lead to cross-talk between pixels if pixels are spaced close enough together. As described in more detail below, other elements can be included to help maintain resolution and contrast when using a volume diffuser as a brightness enhancement element for a direct view emissive display.

For some applications such as direct view displays, pixel resolution and contrast between neighboring pixels is preferably maintained, or even enhanced. As such, TIR frustrators can used that increase brightness at a minimum cost to resolution and contrast. For example, TIR frustrators can be used that couple high angle incidence light out of the device toward the viewer upon a first pass through the TIR frustrator, but that do not recycle in significant amounts the light that does not get directed out of the display toward the viewer in the first pass. Surface diffusers can be a suitable choice for coupling first pass light out of the device while, due to a rough outside surface, inhibiting TIR within the surface diffuser that could lead to cross-talk of light between pixels, and thus reduced resolution. Microstructures can also be a suitable choice because they can be used to redirect first pass light out of the device toward the viewer. In addition, combinations of elements such as volume diffusers with a diffuse surface, surface diffusers followed by a microstructured element, volume diffusers with contrast-maintaining microstructures, and the like can be used to achieve a desired amount of brightness enhancement while also maintaining or enhancing contrast and maintaining resolution.

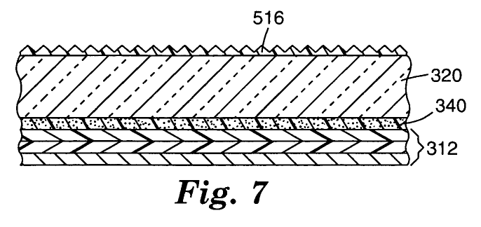

Another example of a TIR frustrator that can maintain resolution is shown in FIG. 6. Element 610 includes transmissive/diffusive regions 612 separated by absorptive regions 614. Absorptive regions 614 can include, for example, microlouvers made of a black material or other light absorptive material. Transmissive/diffusive regions 612 can be made of material(s) suitable for forming a volume diffuser as discussed above. Elements that include absorptive regions such as microlouvers that separate transmissive regions can be made by a variety of techniques, such as those disclosed in U.S. Pat. Nos. 4,621,898; 4,766,023; 5,147,716; 5,204,160; and 5,254,388. Absorptive regions 614 can be used to absorb, or block, light that is internally reflected within element 610. This can prevent some light from propagating laterally over long distances (e.g., to another pixel region) through element 610. By preventing some internally reflected light from traveling into other pixel regions, pixel cross-talk can be reduced. This helps maintain resolution. There can be a trade-off, however, in that internally reflected light that is absorbed by absorptive regions 614 does not contribute to brightness enhancement. However, absorbing this light can result in the maintenance of resolution and contrast.

Alternatively, louvered structures can be formed that do not necessarily include light absorptive regions, but rather specifically include louvers to present reflective interfaces so that light can be reflected toward the viewer, thereby hindering pixel cross-talk while not absorbing the light in substantial amounts.

To help reduce cross-talk between pixels, the spacing between absorptive elements 614 is preferably on the order of the distance between pixels or smaller. For example, the spacing between absorptive elements 614 can be the same as the spacing between pixels, and element 610 can be disposed between the emissive devices 512 patterned into pixels and the substrate 514 so that each pixel emits directly through a transmissive/diffusive region 612. Alternatively, the spacing between absorptive elements 614 can be made much smaller than the pixel spacing so that alignment between pixels and element 610 is less of an issue.

TIR frustrators of the present invention can be optionally equipped with properties that provide functionality in the emissive device. For example, colorants such as dyes or pigments can be dispersed in the binder of a volume diffuser TIR frustrator to provide desired coloration such as in a situation where the emissive light does not exhibit the preferred color coordinates. Colorants can also be disposed in other types of TIR frustrators. Other functionalities that may be desirable to provide integral to a TIR frustrator include polarization, light recycling, contrast enhancement, etc.

TIR frustrators of the present invention can be provided as whole elements that span the entire breadth of a display, can be provided to cover a portion of a display, or can be patterned to cover selected portions of a display in a selected manner. For example, in displays that include a pixilated array of emissive devices, volume diffusers can be patterned so that a single volume diffuser is associated with a single light emitter or group of light emitters. This may have the benefit of being able to select a different type of volume diffuser for each type of light emitter, for example selecting scatterers that perform better at particular wavelengths. Another benefit of patterning TIR frustrators can be the ability to maintain resolution in pixilated displays. For example, by patterning separate volume diffusers and associated each volume diffuser with a particular pixel or sub-pixel, pixel cross talk due to scattering and internal reflections within the volume diffuser may be reduced. Providing a black matrix that separates the patterned volume diffusers and pixels may also help reduce pixel cross talk while enhancing contrast. TIR frustrators can be patterned by any suitable method including various photolithographic methods, printing methods, and selective transfer methods. For example, volume diffusers, microstructures, and the like may be patterned by selectively thermally transferring particles in a binder from a donor sheet to a display substrate by selective laser-induced heating of the donor sheet. It may also be desirable to simultaneously pattern emissive devices and TIR frustrators on display substrates. Selective thermal mass transfer of emissive devices, particles in a binder, and microstructures has been disclosed in U.S. Pat. Nos. 6,114,088; 5,976,698; and 5,685,939 and in co-assigned patent application U.S. Ser. No. 09/451,984.

### EXAMPLES

The following examples are meant to illustrate some aspects of the present invention and are not meant to limit the scope of the claims recited below.

In these examples, brightness enhancement is quantified in terms of gain. Gain is a dimensionless measurement that compares light intensity at a given viewing angle relative to a baseline measurement. For example, the brightness of an emissive device can be measured as a function of viewing angle to determine a baseline. Then, a TIR frustrator can be added to the device and the brightness can be measured again as a function of viewing angle. The ratio of the brightness of the device with the TIR frustrator versus the brightness of the device alone at a given viewing angle is the gain at that viewing angle. A gain of 1.5 at normal incidence, for example, represents a 50% increase in brightness at a 0° viewing angle as compared to the base line measurement. A gain of 0.7 at 80°, for example, represents a 30% decrease in brightness at an 80° viewing angle as compared to a base line measurement.

Various TIR frustrators were tested to compare their relative gains to other TIR frustrators in emissive devices. The emissive devices used to test the performance of the various TIR frustrators included an ultraviolet (uv) light source and a fluorescent dyed polyvinyl chloride (PVC) film disposed on top of the uv light source. The refractive index of the PVC film was 1.524 and the thickness was about 0.25 mm. The uv light source emitted uv photons into the dyed PVC film which excited the dye which in turn emitted visible light. PET films (about 0.07 mm thickness and refractive index of 1.65) were used as substrates. The substrates were disposed on top of the dyed PVC film, and the intensity of the light emitted from the construction was measured as a function of viewing angle. This measurement served as the baseline for all gain measurements made. To test various TIR frustrators in different constructions in the device, the TIR frustrator could be disposed between the PET substrate and the dyed PVC film, on top of the PET substrate, or both. The test construction was intended to simulate a lambertian light emitting device that emits light through a substrate, for example an electroluminescent lamp such as an OLED. The results of using different types of TIR frustrators are reported in the examples below.

### Example 1

### Volume Diffuser

In this example, the gain associated with volume diffusers laminated between the dyed PVC film and the PET substrate was measured as a function of scatterer loading. The volume diffusers were made by dispersing various amounts of Sb₂O₃ particles (refractive index=2.1, average diameter=3 microns) in a thermoplastic PET material (refractive index=1.56) to make mixtures, and coating the mixtures onto the PET substrate using a #20 Meyer bar. The coatings were then dried to form constructions that consisted of volume diffusers bonded to PET substrates. The volume diffusers each had thicknesses of about 4 microns. For each construction, the volume diffuser side was thermally laminated to a dyed PVC film at about 300° F. The resulting samples had, in the following order, a dyed PVC film, a 4 micron thick volume diffuser, and a PET substrate. Each sample was placed on the uv light source and gain was measured as a function of angle. Table 1 reports the gain at normal incidence for each of the samples. Samples are designated by the weight percentage of Sb₂O₃ particles in the volume diffuser.

TABLE 1
Gain as a function of scatterer loading

| Wt. % of Sb₂O₃ | Gain at 0° |
|---|---|
| 0 | 1 |
| 2.5 | 1.58 |
| 5 | 1.78 |
| 10 | 2.05 |
| 20 | 2.39 |
| 40 | 2.70 |
| 50 | 2.72 |

Table 1 indicates that higher particle loadings in the volume diffuser resulted in more light being coupled out of the device. For each of the samples, the maximum gain was at 0° viewing angle, and the gain decreased slowly with increased viewing angle. In the highest particle loading samples (40 wt. % and above), the gain fell below 1 at viewing angles greater than 70°.

In addition to these results, the same construction was used to test gain as a function of volume diffuser thickness at the 50% loading level for particles in the volume diffuser. Those results indicated that the gain eventually dropped for higher volume diffuser thicknesses, although gains greater than 1 at normal incidence were maintained. This indicated that increasing the thickness of volume diffusers that had high particle loadings tended to counteract some of the improvement in gain from the higher particle loading.

### Example 2

### Volume Diffuser

In this example, gain was measured for volume diffuser TIR frustrators as a function of refractive index of a lamination adhesive disposed between the volume diffuser and the dyed PVC film. Volume diffusers were made by dispersing Sb₂O₃ particles in thermoplastic PET (40 wt. % particles to PET) and then coating the mixture onto the PET substrate. The volume diffusers had a thickness of about 4 microns. The volume diffusers were then laminated to the dyed PVC films using various adhesives. The type of adhesive, the refractive index of the adhesive, and the measured gain for each of the samples are reported in Table 2.

TABLE 2
Gain as a function of laminating adhesive refractive index

| | Refractive | |
|---|---|---|
| Adhesive | Index | Gain |
| Low index pressure adhesive | 1.4751 | 2.57 |
| High index pressure adhesive | 1.5447 | 3.02 |
| PET thermoplastic | 1.5567 | 2.76 |

Table 2 indicates that the closer the refractive index of the adhesive was to the refractive index of the dyed PVC film, the higher the observed gain (refractive index of dyed PVC film=1.524). This indicated that better optical coupling between the light emitter and the volume diffuser can result in enhanced brightness.

### Example 3

### Volume Diffuser

In this example, gain was measured for volume diffuser TIR frustrators as a function of the refractive index of a lamination adhesive disposed between the volume diffuser and a glass substrate. The same volume diffusers were made as described in Example 2 (i.e., particles dispersed in thermoplastic PET and coated onto PET substrate). The coated side of the volume diffuser was laminated to a 1 mm thick glass substrate using the various adhesives reported in Table 3. The dyed PVC film was laminated to the other side of the glass substrate using an optically clear adhesive commercially available from Minnesota Mining and Manufacturing under the trade designation 3 M Laminating Adhesive 8141(index of refraction=1.475). The gain for each construction is reported in Table 3.

TABLE 3
Gain as a function of laminating adhesive refractive index

| | Refractive | Δn (glass and | |
|---|---|---|---|
| Adhesive | Index | adhesive) | Gain |
| None (bare glass) | 1.5115 | — | 1 |
| Adhesive 1 | 1.4751 | 0.0364 | 2.71 |
| Adhesive 2 | 1.5039 | 0.0076 | 2.91 |
| Adhesive 3 | 1.5216 | 0.0101 | 2.79 |
| Adhesive 4 | 1.5447 | 0.0332 | 2.69 |

Table 3 indicates that higher gains were achieved when the difference in refractive index between the adhesive and the glass substrate was smaller, although significant gains were observed in each case.

### Example 4

### Cellulose Acetate Film as Surface and Volume Diffuser

A 30 micron thick cellulose acetate film (refractive index=1.49) was embossed with a slightly elongated, matted pattern that had about a 1 to 2 micron depth. This was essentially the same substrate and pattern used in the backing of adhesive tape sold by Minnesota Mining and Manufacturing Company under the trade designation 3M Magic Tape. The embossed surface of the cellulose acetate film was laminated to the dyed PVC film using the 3M Laminating Adhesive 8141. This construction exhibited a gain at normal incidence of 1.681. In addition to the surface roughness provided by the embossing, the cellulose acetate film contained sub-micron sized voids in its bulk. The voids were an artifact created during the embossing process.

### Example 5

### Surface Diffusers

In this example, gain was measured and compared among various surface diffusers. In each case, the described diffusive surface was laminated to the dyed PVC film using the 3M Laminating Adhesive 8141.

Diffusive surface 5A consisted of a plurality of dome-like protrusions on a 0.07 mm thick PET film with an index of refraction of 1.65. Surface 5 A was made by casting PET onto a mold that had an inverted dome structure. The mold was made by replicating off a beaded projection screen where the beads ranged in diameter from 30 microns to 90 microns and had an average diameter of 60 microns.

Diffusive surface 5B was the same as diffusive surface 5A but had the inverted structure (i.e., a plurality of sphere-like indentations).

Diffusive surface 5C was made by stretching a 10%/90% polyethylene/polypropylene film (thickness=0.07 mm, refractive index=1.49) to a 9:1 ratio (stretched direction vs. unstretched direction). Stretching the film roughened the surfaces.

Diffusive surface 5D was a 0.15 mm thick matted polycarbonate film, commercially available from General Electric Corp. under the product code 8B35.

Diffusive surface 5E was the embossed cellulose acetate film described in Example 4.

Diffusive surface 5F consisted of randomly disposed and closely packed boehmite (aluminum trihydrate) microstructures. It was made by hot water vapor steaming of a 600 Angstrom thick aluminum coating on a 0.03 mm thick PET substrate. Diffusive surface 5F had a thickness of about 0.1 microns and a refractive index of 1.58.

Table 4 reports the gain at normal incidence for each of the samples.

TABLE 4
Gain for various surface diffuser TIR frustrators

| Diffusive Surface | Gain |
|---|---|
| 5A | 1.123 |
| 5B | 1.405 |
| 5C | 1.025 |
| 5D | 1.030 |
| 5E | 1.406 |
| 5F | 1.067 |

Table 4 indicates that surface diffusers can be used to enhance the brightness of emissive devices. As can be seen by comparing the gains reported in Table 4 to those reported in Table 1, volume diffusers can be more efficient in coupling light out of emissive devices than surface diffusers. This is likely due to the nature of volume diffusers that allows multiple chances for light to be scattered forward toward the viewer. It should also be noted that gain increased as a function of viewing angle for the surface diffusers reported in this Example 5. This can be contrasted with the behavior of volume diffusers that tended to exhibit a reduction in gain for higher viewing angles. This suggests that relatively high gains might be achieved over a wide range of viewing angles in emissive displays that combine volume diffusers and surface diffusers as TIR frustrators.

### Example 6

### Microstructures

In this example gain was measured and compared among various microstructured samples. In each case, the described microstructured sample was laminated to the dyed PVC film (with the microstructure oriented toward the dyed PVC film) using the 3M Laminating Adhesive 8141.

Microstructure 6A was a sinusoidal surface grating having a plurality of parallel ridges spaced about 0.8 microns apart and rising to a height of about 0.026 microns above the main surface. The grating was formed by thermal embossing a 5 micron thick coating of thermoplastic PET on a 0.07 mm thick PET film.

Microstructure 6B was an array of microlenses molded into a hot melt injected 0.10 mm thick polycarbonate film (index=1.58).

Microstructure 6C was a lenticular array molded into a PET film by photopolymer casting. The cylindrical lenses that made up the lenticular sheeting had a spatial frequency of 78 microns, elliptical lens height of 23 microns, and a long axis to short axis aspect ratio of 1.35. The photopolymer had an index of refraction of 1.57 after curing.

The microlens array 6B had essentially the same spatial frequency, lens height, and aspect ratio as microstructure 6C except that the lens array 6B was a two-dimensional array of lenses whereas the lenticular array 6C consisted of cylindrical lenses.

Table 5 reports the gain at normal incidence for each of these samples.

TABLE 5
Gain for various microstructured TIR frustrators

| Microstructure | Gain |
|---|---|
| 6A | 1.309 |
| 6B | 1.048 |
| 6C | 1.090 |

As with the surface diffusers described in Example 5, the microstructured surfaces exhibited higher gains at higher viewing angles. The surface grating of microstructure 6A exhibited its highest gains for viewing angles between about 25° and 60°.

### Example 7

### Microstructures

In this example, gain was measured as a function of viewing angle and viewing orientation for similar microstructured prismatic films. The microstructured films consisted of a plurality of parallel V-shaped grooves spaced 50 microns apart. The grooves defined peaks, or prisms, that had a 66° apex angle. The microstructure was made by casting a photopolymer (refractive index=1.57) onto a PET film. Three different microstructured films were made, the first having 0 micron “flat”(the “flat” is the width of the flat valley portion between microstructures), the second having 5 micron flat, and the third having 10 micron flat. The microstructured films were filled (on their microstructure side) with polyvinylacetate (PVAc, refractive index=1.466), which was leveled to make a smooth surface. The PVAc surface was then laminated to the dyed PVC film using the 3M Laminating Adhesive 8141. Gain was then measured over a range of viewing angles, and is reported below in Table 6 at normal incidence and at a 20° viewing angle. The gain at off-normal viewing angles was measured at two orientations, namely with the viewing angle measured parallel to the groove direction (H) and perpendicular to the groove direction (V). The 20° viewing angle is reported below because it exhibited the maximum gain in the V direction.

TABLE 6
Gain as a function of viewing angle and orientation
for prismatic film TIR frustrator

| Land | | Gain at 20° |
|---|---|---|
| (microns) | Gain at 0° | (orientation) |
| 0 | 1.22 | H 1.29 |
| | | V 2.79 |
| 5 | 1.13 | H 1.20 |
| | | V 2.74 |
| 10 | 1.10 | H 1.15 |
| | | V 2.62 |

Table 6 indicates that brightness enhancement can have an angular dependence. For some applications, it may be desirable to increase the gain preferentially in a particular orientation and at an off-normal viewing angle. For example, hand-held devices are often titled back slightly so that the viewer is observing the display at a slightly inclined viewing angle.

### Example 8

### Combination of Volume Diffusers with Microstructures

The following example compares the gain of various constructions that include volume diffusers having different particle loadings and/or different thicknesses. In addition, the gain of each construction is compared with and without an added prismatic film.

Particles of Sb₂O₃ were dispersed in an acrylic commercially available from BF Goodrich Co. under the trade designation Carboset 525(refractive index of 1.48) at various particle loadings. The weight percentages of the various loadings were as indicated in Table 7. The mixtures were coated onto the PET substrates and dried to form volume diffusers. Except as indicated in Table 7, the thickness of the volume diffuser coatings were about 4 microns. The volume diffusers were then laminated to the dyed PVC films, with the volume diffuser side oriented toward the dyed PVC film, using the 3M Laminating Adhesive 8141.

In each case, gain was measured with and without a prismatic film. When a prismatic film was used, the prismatic film was placed on top of the laminate, with the prisms oriented away from the laminate, with an air gap between the prismatic film and the laminate. The prismatic film used was the optical film commercially available from Minnesota Mining and Manufacturing Company under the trade designation BEF III. It is made of a photopolymer having an index of 1.57, and has a plurality of parallel V-shaped grooves that form parallel prisms having a prism angle of 90° and an average prism pitch of 50 microns.

TABLE 7
Gain as a function of particle loading, volume diffuser
thickness, and presence of prismatic film

| Wt. % of Sb₂O₃ | Gain | Gain with BEF III |
|---|---|---|
| 2.5 | 1.60 | 1.93 |
| 5 | 1.77 | 2.15 |
| 10 | 1.97 | 2.37 |
| 20 | 2.23 | 2.66 |
| 30 | 2.32 | 2.73 |
| 40 | 2.38 | 2.81 |
| 50 | 2.40 | 2.84 |
| 50 (9 microns thick) | 2.36 | 2.84 |
| 50 (13 microns thick) | 2.02 | 2.53 |

Table 7 indicates that gain can be increased by increasing particle loading in a volume diffuser. Table 7 also indicates that including a volume diffuser TIR frustrator between an emissive device and a substrate and additionally including a prismatic film on the opposing side of the substrate can further increase gain as compared to the volume diffuser alone. Table 7 also indicates that for high enough particle loading, there may be thickness limitations to volume diffusers, above which thicknesses the density of scattering centers can have detrimental effects that counteract the beneficial effects.

It should be noted that a large dependence of gain on viewing angle was observed when the prismatic films were used in addition to the volume diffusers for brightness enhancement. When using volume diffusers alone, the observed gain was highest at normal incidence and gradually decreased at higher viewing angles, but still remained above 1 (and in many cases above 1.5) for viewing angles of up to 60° or more depending on the particle loading (higher particle loadings exhibited a faster decrease in gain at higher viewing angles). When using the prismatic film in addition, gain was higher at normal incidence than without the prismatic film, and the gain gradually decreased up to viewing angles of about 30° to 35°. At 30° to 35°, a sharp decrease in gain was observed to gains well below 1, and a minimum in gain was observed between about 40° and 50° viewing angle. Above about 50°, gain was again observed to increase, but still remained less than 1. The angular dependence of the gain mirrored the angular dependence of gain using the prismatic film alone with no volume diffuser, although with the volume diffuser and the prismatic film, the gain was higher for all viewing angles than with the prismatic film alone.

### Example 9

### Volume Diffusers having Different Binders

In this example, the gain associated with volume diffusers laminated between the dyed PVC film and the PET substrate was measured as a function of the binder used to make the volume diffuser. Volume diffusers were made by dispersing Sb₂O₃ particles (average diameter of 3 microns) in different binders at a 2:3 by weight ratio of particles to binder. The particles/binder mixtures were then coated the PET substrate using a #20Meyer bar. The coatings were then dried to form constructions that consisted of volume diffusers bonded to PET substrates. The volume diffusers each had thicknesses of about 4 microns. For each construction, the volume diffuser side was thermally laminated to a dyed PVC film at about 300° F. The resulting samples had in the following order a dyed PVC film, a 4 micron thick volume diffuser, and a PET substrate. Each sample was placed on the uv light source and gain was measured as a function of angle.

Table 8 reports the gain at normal incidence for each of the samples. The binder material and refractive index of each volume diffuser is given in the table. The binder material “PentalynC/Elvax” cited in Table 8 was a blend of materials chosen to achieve a refractive index that closely matched the dyed PVC film (refractive index of 1.524). The materials used for this binder were a tackifier available from Hercules (Wilmington, Del.) under the trade designation PentalynC (refractive index of 1.546) and a vinyl acetate/ethylene copolymer blend available from Du Pont (Wilmington, Del.) under the trade designation Elvax 210 (refractive index of 1.501).

TABLE 8
Gain as a function of binder index

| | Refractive Index | |
|---|---|---|
| Binder Material | of Binder | Gain |
| acrylic | 1.48 | 2.4 |
| PentalynC/Elvax | 1.526 | 3.15 |
| polyethylene | 1.56 | 2.7 |
| PVC | 1.54 | 2.63 |

Recall that the refractive index of the dyed PVC film was 1.524. Table 8 indicates that a higher gain was observed when the refractive index of the binder more closely matched the refractive index of the dyed PVC film which was positioned immediately below the volume diffuser in the display construction. Table 8 also indicates that binders having a slightly higher refractive index than the dyed PVC film showed higher gain than binders having a comparably lower refractive index than the dyed PVC film.

All of the patents and patent applications cited are incorporated into this document in total as if reproduced in full. Various modifications and alterations of this invention will be apparent to one skilled in the art from the description herein without departing from the scope of this invention.

1-3. (Cancelled)

4. An information display comprising:
a light emitted device capable of displaying information disposed to emit light through a transmissive layer, thereby displaying the information to a viewer; and
a volume diffuser disposed to receive light from the light emitting device and to frustrate total internal reflections of light emitted by the light emitting device, wherein the volume diffuser comprises voids dispersed in a matrix material.

5. The information display of claim 4, wherein the volume diffuser further comprises a diffusive surface oriented toward the transmissive layer.

6. The information display of claim 4, wherein the volume diffuser further comprises a microstructured surface oriented toward the transmissive layer.

7. (Cancelled)

8. The information display of claim 4, wherein the volume diffuser further comprises a plurality of louvers disposed to maintain the resolution of the light emitting devices.

9. The information display of claim 8, wherein the louvers are primarily absorptive of light.

10. The information display of claim 8, wherein the louvers are primarily reflective of light.

11. An information display comprising:
a transmissive layer;
a light emitting, device capable of displaying information disposed to emit light through the transmissive layer, thereby displaying the information to a viewer; and
a frustrator element comprising a surface diffuser to frustrate total internal reflections of light emitted by the light emitting device, wherein the transmissive layer is disposed between the frustator element and the light emitting device.

12. An information display comprising:
an optically transmissive layer:
a light emitting device capable of displaying information disposed to emit light through the transmissive layer, thereby displaying the information to a viewer;
a first frustrator element displayed onto the transmissive layer and having a microstructured surface facing the viewer, the microstructured surface comprising a plurality of prismatic microstructures; and
a second frustrator element comprising a volume diffuser disposed between the microstructured surface an the light emitting device, the first and second frustrator elements frustrating total internal reflections of light emitted by the light emitting device.

13. (Cancelled)

14. The information display of claim 4, wherein the light emitting device comprises an electroluminescent light emitting devices.

15. The information display of claim 4, wherein the light emitting device comprises an organic electrolumninescent light emitting devices.

16. The information display of claim 4, wherein the light emitting device comprises a phosphor-based light emitting devices.

17. The information display of claim 4, further comprising a prismatic film disposed on a side of the transmissive layer opposing the light emitting devices.

18. The information display of claim 4, wherein the volume diffuser is disposed between the light emitting devices and the transmissive layer.

19. The information display of claim 4, wherein the volume diffuser is disposed between the transmissive layer and a viewer position.

20. The information display of claim 8, wherein the volume diffuser is disposed between the emissive devices and the transmissive layer.

21. The information display of claim 8, wherein the volume diffuser is disposed between the transmissive layer and a viewer position.

22. An information display comprising:
an optically transmissive layer;
a light emitting device capable of displaying information disposed to emit light through the transmissive layer toward a viewer;
a first frustrator element disposed onto the transmissive layer and having a microstructured surface facing the viewer; and
a second frustrator element comprising a volume diffuser disposed between the microstructured surface and the transmissive layer, the first and second frustrator elements frustrating total internal reflections of light emitted by the light emitting device.
